(19) United States
(12) Patent Application Publication
(10) Pub. No.: US 2021/0393475 A1
(43) Pub. Date: Dec. 23, 2021

(54) MASSAGE DEVICE INTEGRATED WITH ELECTRICAL PRESSING,TAPPING AND VIBRATION FUNCTIONS

(71) Applicant: Shenzhen S-Hande Technology Co., Ltd., Shenzhen (CN)

(72) Inventor: Jing HE, Shenzhen (CN)

(21) Appl. No.: 16/932,859

(22) Filed: Jul. 20, 2020

(30) Foreign Application Priority Data
Jun. 18, 2020 (CN) 202010558801.5

(51) Int. Cl. A61H 23/00; A61H 23/02

(52) U.S. Cl. CPC A61H 23/006; A61H 23/0263; A61H 2201/5035; A61H 2201/0192; A61H 2201/169

(57) ABSTRACT

A massage device integrated with electrical pressing, tapping and vibration functions includes a main body including a PCB, a battery, a first vibration motor and a telescopic member, and a soft rubber shell surrounding around the main body; the PCB electrically connected to the battery and the first vibration motor connected with the telescopic member exposed the main body; the soft rubber shell including a massaging portion at an exposed position of the telescopic member, a bottom portion of the massaging portion connected with the telescopic member; the first vibration motor configured to rotate and vibrate to drive the telescopic member to reciprocate up and down and drive the massaging portion to press, pat and adsorb a portion touched with human body. The present structure can combine various massage ways to massage a sexual response area of the human body so as to strengthen massage effect and enhance massage experience.

### BACKGROUND

### 1. Technical Field

The present disclosure generally relates to sex massage devices field, and especially relates to a massage device integrated with electrical pressing, tapping and vibration functions.

### 2. Description of Related Art

Many kinds of massage devices are provided for massaging different areas of human body, such as a neck, shoulders, a waist, legs, and sexual response areas.

A conventional massage device for massaging the sexual response areas is to generally obtain sexual pleasure experience by stimulating human sexual organs such as nipples, a female vagina, a clitoris, a male prostate and so on. At present, the conventional sexual response area massage device on the market can only provide a single massage way such as vibration, twitch, rotation and pull, so that it can only obtain a poor massage effect and a poor experience with the single massage way.

Therefore, a new massage device should be developed in order to solve the problems shown above.

### SUMMARY

The technical problems to be solved: in view of the shortcomings of the related art, the present disclosure relates to a massage device integrated with electrical pressing, tapping and vibration functions which can combine various massage ways to massage a sexual response area of a human body so as to strengthen massage effect and enhance massage experience.

The technical solution adopted for solving technical problems of the present, disclosure is:

A massage device integrated with electrical pressing, tapping, and vibration functions includes a main body and a soft rubber shell surrounding around the main body;

the main body including a PCB, a battery, a first vibration motor and a telescopic member, the PCB electrically connected to the first vibration motor and the battery, and the first vibration motor connected to the telescopic member;

the telescopic member exposed at one end of the main body and the soft rubber shell including a massaging portion at an exposed position of the telescopic member which can expose out of the end of the main body, a bottom portion of the massaging portion connected with the telescopic member; and wherein

the first vibration motor is configured to rotate and vibrate to drive the telescopic member to reciprocate up and down and then drive the massaging portion to press, pat and adsorb a portion in contact with, a human body.

Wherein the massaging portion is a massaging protrusion arranged outside the soft rubber shell and protruding outward or a massaging concave recessed inside the soft rubber shell or appeared parallel and level with a surface of the soft rubber shell.

Wherein the telescopic member includes an eccentric gear, an eccentric shaft and a pushing rod connected in turn, one edge of the eccentric gear fixedly connected with an output shaft of the first vibration motor and rotated with the rotation of the first vibration motor, and the other edge of the eccentric gear connected with the eccentric shaft; a lower portion of the pushing rod sleeved around outside the eccentric shaft and rotatably connected with the eccentric shaft, and an upper portion of the pushing rod exposed out of the main body and connected with a bottom portion of the massaging portion, the eccentric shaft eccentrically rotating with the rotation of the eccentric gear to further drive the pushing rod to reciprocate up and down.

Wherein the pulling rod includes a post formed on a middle thereof, a hollow sleeving member arranged at a lower edge of the post, and a convex cap arranged at an upper edge of the post, the eccentric shaft inserted into the hollow sleeving member to rotate relative to the sleeving member, the convex cap exposed the main body and connected with the bottom portion of the massaging portion.

Wherein the soft rubber shell includes a massaging protrusion formed on a position thereof that the convex cap is exposed, a first clamping cavity formed below a bottom end of the massaging protrusion so that the convex cap can be embedded into the first clamping cavity.

Wherein the main body includes a front shell for receiving the first vibration motor and the telescopic member therein, a back shell for receiving the battery and the PCB therein, and a silicone connecting member connected with the front shell and the back shell, the front shell including an opening formed on a top end thereof for the convex cap exposing therefrom;

the soft rubber shell including a housing surrounding, around all the front shell, the silicone connecting member and the back shell, a massaging, bar extending diagonally upward towards the front shell from the housing, and a mounting cover, the housing including a first mounting recess formed corresponding to a distal end of the back shell so that the mounting cover can cover on the first mounting recess, the massaging protrusion integrated with the housing and formed at a position of the housing where the convex cap is exposed to the front shell; and massaging bar to vibrate.

Wherein the massaging bar includes a pair of massaging ears thereon.

Wherein the soft rubber shell includes a massaging concave formed on a position thereof that the convex cap is exposed, a second clamping cavity formed below a lower end of the massaging concave so that the convex cap can be embedded into the second clamping cavity.

Wherein the main body includes a front shell for receiving the first vibration motor and the telescopic member therein, a back shell for receiving the battery and the PCB therein, and an elastic member connected with the front shell and the back shell, the front shell including an opening fanned on a top end thereof for the convex cap exposing therefrom;

the soft rubber shell including a housing surrounding, around all the front shell, the elastic member and the back shell, and a massaging concave cover, the housing including a second mounting recess formed at a position where the convex cap is exposed to the front shell so that the massaging concave cover can cover on the second mounting recess, the massaging concave cover including a massaging room with an upper recess thereof to form the massaging concave, and the second clamping cavity formed below the bottom of the massaging room; and

a third vibration motor received in the back shell to drive the back shell to vibrate.

Wherein the back shell includes a control button and a charging member, both the control button and the charging member exposed outward the back shell and electrically connected to the PCB, the charging member passing through the housing and connected with an external power supply to charge the battery, and the control button configured to open and close the massage device and control parameters of the massage device.

Wherein the sleeving member includes a blocking bar formed on one portion thereof, and a limiting buckle formed on the other portion thereof, one end surface of the eccentric shaft resisted against the blocking bar and the other end surface of the eccentric shaft held by the limiting buckle, when the eccentric shaft is mounted on the sleeving member.

Wherein each expansion joint is formed on a front end and a back end of the silicone connecting member and includes a slot formed on an outer wall thereof, when the expansion joints at the front end and the back end are respectively received in the front shell and the back shell, the slots are respectively clamped with the front shell and the back shell.

Wherein the elastic member includes a soft axis and a soft sleeve, one end of the soft axis and one portion of the soft sleeve installed in the front shell, and the other end of the soft axis and the other portion of the soft sleeve installed in the back shell, a groove formed on an inner wall of the soft sleeve to clamp with the front and back shells.

The present disclosure provides the advantages as below.

The structure of the present disclosure is provided that a first vibration motor and a telescopic member installed in a main body, a massaging portion formed on a position of the soft rubber shell that the telescopic member can expose the main body, the first vibration motor rotated with high speed to produce a vibration massage effect and simultaneously drive the telescopic member to reciprocate up and down so that up and down reciprocating movement of the telescopic member can drive the massaging portion to press, pat, adsorb and stretch a portion in contact with a human body to massage the portion of the human body by vibrating, pressing, patting, adsorbing and stretching the contact point of the human body. The structure of the present disclosure can obtain functions of pressing, patting, adsorbing and stretching by an eccentric gear and an eccentric shaft of the telescopic member pushing a pushing rod to move along its tracks. Furthermore, the structure of the present disclosure not only can provide a conventional vibration massage effect on the contact point of the human body, but also can provide experience effect of pressing, tapping or absorbing, stretching and multiple massage combinations of them to improve good personal experience effect.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of a massage device integrated with electrical pressing, tapping and vibration functions in accordance with a first embodiment of the present disclosure.

FIG. 2 is a cross section view of the massage device integrated with electrical pressing, tapping and vibration functions of FIG. 1.

FIG. 3 is an exploded, schematic view of a telescopic member and a first vibration motor of the massage device integrated with electrical pressing, tapping and vibration functions of FIG. 2.

FIG. 4 is a schematic view of a pushing bar of the massage device integrated with electrical pressing, tapping and vibration functions of FIG. 2.

FIG. 5 is an exploded, schematic view of the massage device integrated with electrical pressing, tapping and vibration functions of FIG. 1.

FIG. 6 is similar to FIG. 5, but shown from another view.

FIG. 7 is a schematic view of a massage device integrated with electrical pressing, tapping and vibration functions in accordance with a second embodiment of the present disclosure.

FIG. 8 is a cross section view of the massage device integrated with electrical pressing, tapping and vibration functions of FIG. 7.

FIG. 9 is similar to FIG. 8, but shown from another view.

FIG. 10 is an exploded, schematic view of the massage device integrated with electrical pressing, tapping and vibration functions of FIG. 7.

FIG. 11 is a schematic view of a massaging concave cover of the massage device integrated with electrical pressing, tapping and vibration functions of FIG. 8.

The element labels according to the exemplary embodiment of the present disclosure shown as below:

100 massage device integrated with electrical pressing, tapping and vibration functions, 1 main body, 1a one end, 11 front shell, 11a top end, 111 opening, 12 back shell, 12a distal end, 13 silicone connecting member, 13a front end, 13b back end, 131 expansion joint, 131a outer wall, 11b slot, 14 elastic member, 14a two portions, 14b inner wall, 14c groove, 141 soft axis, 142 soft sleeve, 2 soft rubber shell, 20 massaging portion, 20a bottom portion, 21 housing, 211 massaging protrusion, 211a bottom end, 212 first clamping cavity, 213 first mounting recess, 214 second mounting recess, 22 massaging bar, 221 massaging ear, 23 mounting cover, 24 massaging concave cover, 24a upper recess, 241 massaging concave, 241a lower end, 242 second clamping cavity, 243 massaging room, 243a bottom, 243b bottom wall, 3 PCB, 4 battery, 5 first vibration motor, 5a output shaft, 6 telescopic member, 61 eccentric gear, 61a one edge, 61b the other edge, 62 eccentric shaft, 62a end surface, 62b the other end surface, 63 pushing rod, 63a lower portion, 63b upper portion, 631 post, 631a lower edge, 631b upper edge, 632 sleeving member, 632a one portion, 632b the other portion, 6321 blocking bar, 6322 limiting buckle, 633 convex cap, 7 second vibration motor, 8 third vibration motor, 91 control button, 92 charging member.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

In the description of the present disclosure, it needs to be explained that all the directional indicators (such as the terms: “upper”, “below”, “left”, “right”, “front”, “back” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

In the description of the present disclosure, except where specifically otherwise illustrated or limited, the terms “connect” and “link” used herein should be understood in a broad sense. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure.

Furthermore, in the description of the present disclosure, the terms such as “first” and “second” shown in the specification are only used to describe, but not indicated that the elements of the present disclosure is important or represented the amount of the elements. That is, the features limited by the terms of “first” and “second” may explicitly or implicitly include one or more features.

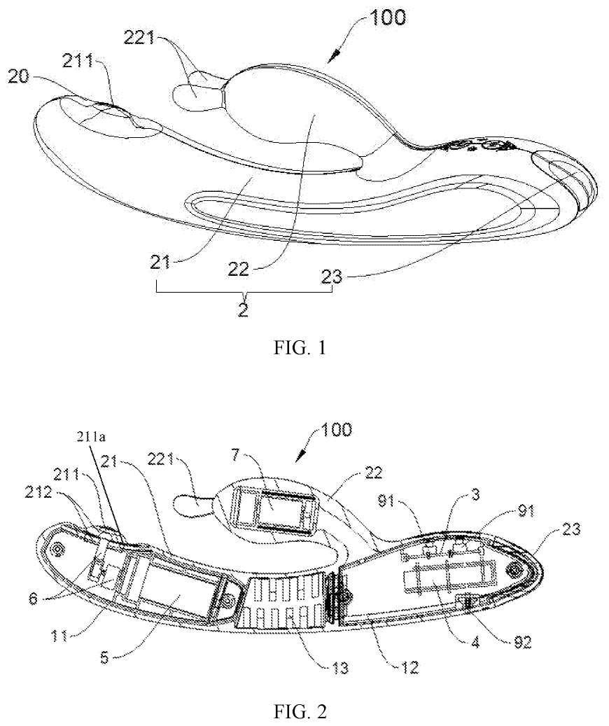

Referring to FIGS. 1-2 and FIGS. 7-8, a massage device integrated, with electrical pressing, tapping and vibration functions 100 in accordance with an embodiment of the present disclosure includes a main body 1 and a soft rubber shell 2 surrounding around the main body 1. Preferably, the main body 1 is a finger-shaped configuration and the soft rubber shell 2 is made of stretchable elastic materials such as silica gel.

The main body includes a PCB 3, a battery 4, a first vibration motor 5 and a telescopic member 6. The PCB 3 is electrically connected to the first vibration motor 5 and the battery 4, and the first vibration motor 5 is connected to the telescopic member 6.

The telescopic member 6 is exposed at one end 1a of the main body 1 and the soft rubber shell 2 includes a massaging portion 20 at an exposed position of the telescopic member 6 which can expose out of the end 1a of the main body 1. A bottom portion 20a of the massaging portion 20 is connected with the telescopic member 6.

A sexual response area of a human body may be a convex configuration, a concave configuration, or a planar configuration, in order to accommodate different, shapes of the sexual response area of the human body, furthermore, the massaging portion 20 is a massaging protrusion 211 arranged outside the soft rubber shell 2 and protruding outward, or a massaging concave 241 recessed inside the soft rubber shell 2 or appeared parallel and level with a surface of the soft rubber shell 2.

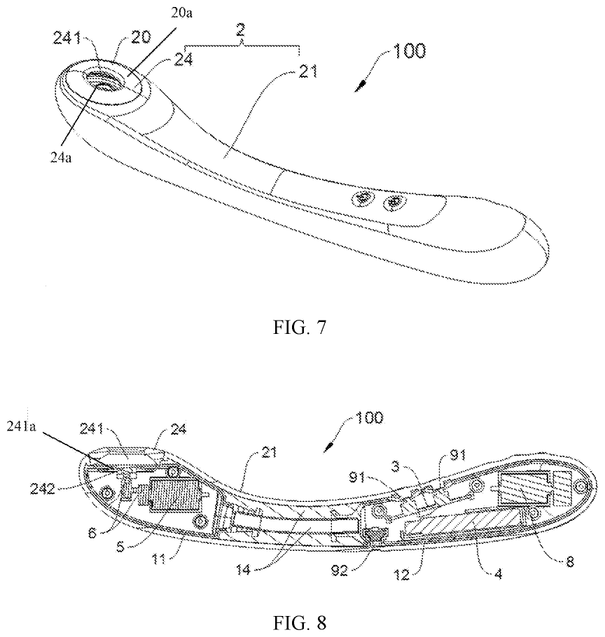

Referring to FIG. 1 and FIG. 2, the massaging protrusion 211 is formed at an exposed position of the telescopic member 6 which can expose out of the end 1a of the main body 1. Referring to FIG. 7 and FIG. 8, the massaging concave 241 is formed at an exposed position of the telescopic member 6 which can expose out of the end 1a of the main body 1. It can be understood, in other embodiments of the present disclosure, the massaging protrusion 211 formed at an exposed position of the telescopic member 6 which can expose out of the end 1a of the main body 1 can be a tongue protrusion, a brush protrusion, or a concave and convex combination structure for massaging the human body. At the same time, the structure of the massaging protrusion 211 can also be designed higher than a surface of the soft rubber shell 2, lower than the surface of the, soft rubber shell 2 or even parallel and level with the soft rubber shell 2.

The first vibration motor 5 is configured to rotate and vibrate to drive the telescopic member 6 to reciprocate up and down and then drive the, massaging portion 20 to press, pat and adsorb a portion in contact with the human body.

The battery 4 is configured to supply power for the PCB 3 and the first vibration motor 5, and the PCB 3 is configured to control to start or stop the first vibration motor 5. A high speed rotation of the first vibration motor 5 can generate vibration so as to drive the main body 1 and the soft rubber shell 2 to vibrate for massaging a contact point of the human body's sexual response area. In addition, during rotation of the first vibration motor 5, the, telescopic member 6 is driven by the first vibration motor 5 to reciprocate up and down, that is, a rotation action can be converted into a reciprocating action up and down by the telescopic member 6.

The telescopic member 6 is driven to reciprocate up and down and then drive the massaging portion 20 to press, pat and adsorb a portion in contact with the human body so as to massage the portion of the human body by vibrating, pressing, patting, and negative-pressure adsorbing the contact point of the human body.

The product of the present disclosure has different stimulation effects for stimulating different points of the human body and then under the motion state of the product, so that it can obtain some main effects such as tapping, pressing and adsorption functions.

When the massaging portion 20 is the massaging protrusion 211, it can press on a protruding stimulation point and a flat stimulation point of the human body, and tap on a concave stimulation point of the human body.

When the massaging portion 20 is the massaging concave 241, it can tap on a protruding stimulation point of the human body, and pressure and adsorption stimulation can be applied on a flat stimulation point and a concave stimulation point of the human body.

When the massaging portion 20 is a surface, it can press on a flat stimulation point of the human body, tap on a protruding stimulation point of the human body, and pressure and adsorption stimulation can be applied on a concave stimulation point of the human body.

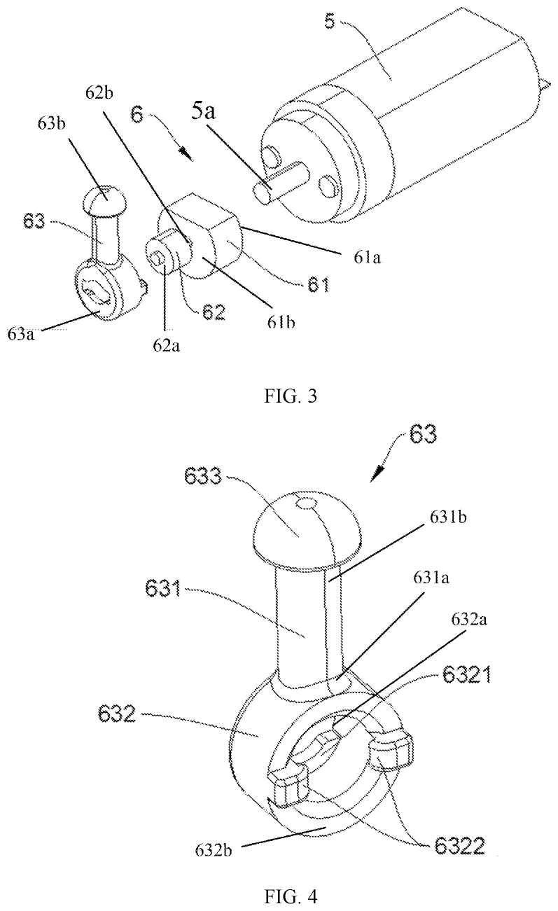

Referring to FIG. 3, the telescopic member 6 of the present disclosure includes an eccentric gear 61, an eccentric shaft 62 and a pushing rod 63 connected in turn. One edge 61a of the eccentric gear 61 is fixedly connected with an output shaft 5a of the first vibration motor 5 and rotated with the rotation of the first vibration motor 5, and the other edge 61b of the eccentric gear 61 is connected with the eccentric shaft 62. A lower portion 63a of the pushing rod 63 is sleeved around outside the eccentric shaft 62 and rotatably connected with the eccentric, shaft 62, and an upper portion 63b of the pushing rod 63 is exposed out of the main body 1 and connected with the bottom portion 20a of the massaging portion 20. The eccentric shaft 62 can rotate eccentrically with the rotation of the eccentric gear 61 to further drive the pushing rod 63 to reciprocate up and down. Due to the eccentric rotation of the eccentric gear 61, the eccentric axis 62 will move up and down. As the eccentric shaft 61 and a lower portion 63a of the pushing rod 63 can rotate relatively, the track of the eccentric shaft 61 moving up and down can push the pushing rod 63 to move up and down reciprocally, thus driving the massaging portion 20 such as the massaging protrusion 211 or the massaging concave 241, to move up and down. Massage effects of pressing and tapping on the protruding contact point of the human body, and the negative-pressure absorbing and stretching on the concave contact point or the planar contact point of the human body can be obtained by the massaging portion 20 moving up and down.

Referring to FIG. 4, the pushing rod 63 of the present disclosure includes a post 631 formed on a middle thereof, a hollow sleeving member 632 arranged at a lower edge 631a of the post 631, and a convex cap 633 arranged at an upper edge 631b of the post 631. The eccentric shaft 62 is inserted into the hollow sleeving member 632 to rotate relative to the sleeving member 632, and the convex cap 633 is exposed the main body 1 and connected with the bottom portion 20a of the massaging portion 20. That is, a rotation connection assembly between the sleeving member 632 and the, eccentric shaft 62 is equivalent to a bearing structure, so that the pushing rod 63 can not only connect with the eccentric shaft 62, but also convert the rotation of the eccentric shaft 62 into the up and down movement of the pushing rod 63. Preferably, the pushing rod 63 can move up and down to drive the convex cap 633 to move up and down with a distance of 2 mm-4 mm.

Preferably, a hollow part of the sleeving member 632 in an embodiment of the present disclosure is slidably and rotatably connected with the eccentric shaft 62, thereby the eccentric shaft 62 and the hollow part of the sleeving member 632 can be engaged with each other by clearance fit.

Furthermore, the sleeving member 632 includes a blocking bar 6321 formed on one portion 632a thereof, and a limiting buckle 6322 formed on the other portion 632b thereof, and one end surface 62a of the eccentric shaft 62 is resisted against the blocking bar 6321 and the other end surface 62b of the eccentric shaft 62 is held by the limiting buckle 6322, when the eccentric shaft 62 is mounted on the sleeving member 632, so as to prevent the eccentric shaft 62 from falling out of the sleeving member 632 and affecting usage reliability of the product.

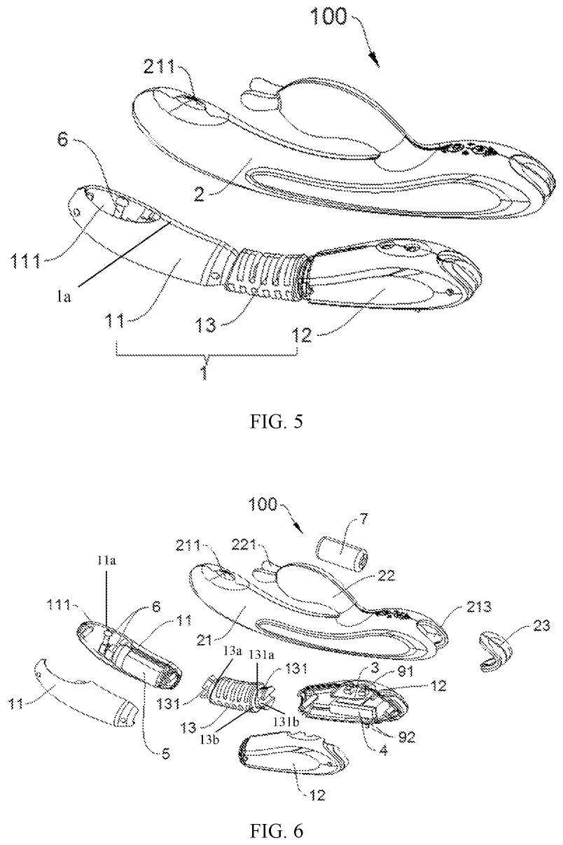

Referring to FIGS. 1-6, in a first embodiment of the present disclosure, the soft rubber shell 2 includes a massaging protrusion 211 formed on a position thereof that the convex cap 633 is exposed, a first clamping cavity 212 formed below a bottom end 211a of the massaging protrusion 211 so that the convex cap 633 can be embedded into the first clamping cavity 212. That is, the massage device according to the first embodiment of the present disclosure is set with the massaging protrusion 211 on the soft rubber shell 2 to obtain a combination massage effect of vibration, pressing and tapping at the contact point of the human body.

Specifically, in the first embodiment of the present disclosure, the main body 1 includes a front shell 11 for receiving the first vibration motor 5 and the telescopic member 6 therein, a back shell 12 for receiving the battery 4 and the PCB 3 therein, and a silicone connecting member 13 connected with the front shell 11 and the back shell 12. The front shell 11 includes an opening 111 formed on a top end 11a thereof so that the convex cap 633 can be exposed from the opening 111. The back shell 1 is configured for being handheld. The silicone connecting member 13 is provided that a soft connection is formed between the front shell 11 and the back shell 12 so that the front shell 11 can swing relative to the back shell 12.

Preferably, each expansion joint 131 is formed on a front end 13a and a back end 13b of the silicone connecting member 13 and includes a slot 131b formed on an outer wall 131 thereof. When the expansion joints 131 at the front end 13a and the back end 13b are respectively received in the front shell 11 and the back shell 12, the slots 131b are respectively clamped with the front shell 11 and the back shell 12, so as to prevent the front end 13a and the back end 13b from respectively protruding out of the front shell 11 and the back shell 12.

The soft rubber shell 2 includes a housing 21 surrounding around all the front shell 11, the silicone connecting member 13 and the back shell 12, a massaging bar 22 extending diagonally upward towards the front shell 11 from the housing 21 and a mounting cover 23. The housing 21 includes a first mounting recess 213 formed corresponding to a distal end 12a of the back shell 12 so that the mounting cover 23 can cover on the first mounting recess 213, the massaging protrusion 211 formed at a position of the housing 211 where the convex cap 633 is exposed to the front shell 11. A second vibration motor 7 is received in the massaging bar 22 to drive the massaging bar 22 to vibrate. The second vibration motor 7 is electrically connected to the PCB 3, and both the main body 1 and the second vibration motor 7 is first installed in the first mounting recess 213 and then received in the soft rubber shell 2.

That is, the massage device 100 in the first embodiment of the present disclosure, the vibration massage can also be provided by the massaging bar 22 in contact with the human body, in addition to provide vibration, pressing and patting massages by the massaging protrusion 211 in contact with the human body. That is to say, the massage device 100 of the first embodiment can simultaneously act on at least two contact points of the human body for massage.

Preferably, the massaging bar 22 includes a pair of massaging ears 221 formed thereon so as to increase contact points touched with the human body, and enhance the vibration massage effect.

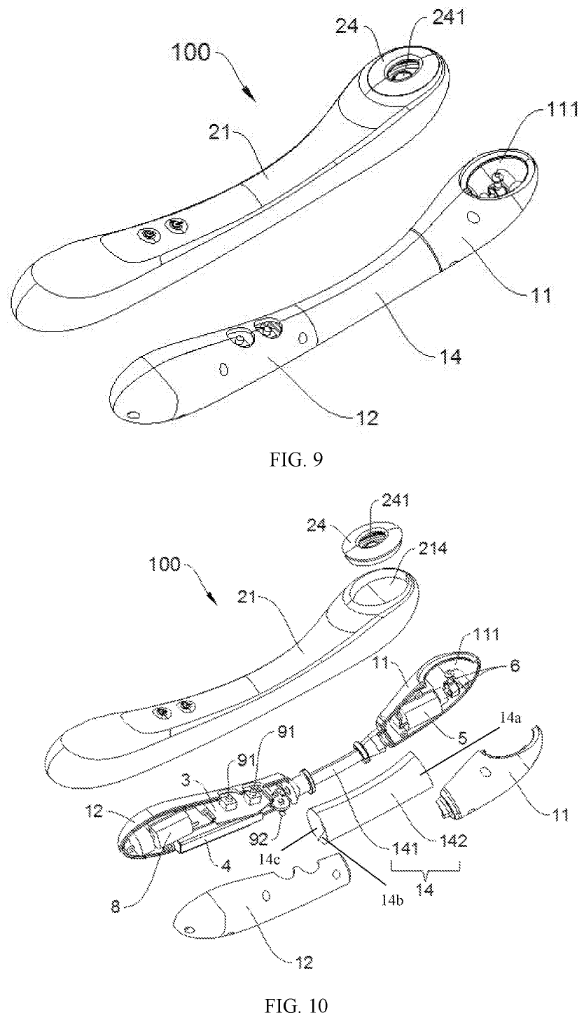

Referring to FIGS. 7-11, the soft rubber shell 2 according to a second embodiment of the present disclosure includes the massaging concave 241 formed on a position thereof that the convex cap 633 is exposed, and a second clamping cavity 242 formed below a bottom end 241a of the massaging concave 241 so that the convex cap 633 can be embedded into the second clamping cavity 242. That is, the massage device 100 according to the second embodiment of the present disclosure is set with the massaging concave 241 on the soft rubber shell 2 to obtain a combination massage effect of vibration, negative-pressure adsorbing, stretching and tapping at the contact point of the human body.

Specifically, the main body 1 includes a front shell 11 for receiving the first vibration motor 5 and the telescopic member 6 therein, a back shell 12 for receiving the battery 4 and the PCB 3 therein, and an elastic member 14 connected with the front shell 11 and the back shell 12. The front shell 11 includes an opening 111 fowled on a top end 11a thereof so that the convex cap 633 can expose from the opening 111. The back shell 12 is configured for being handheld. The elastic member 14 is provided that a soft connection is formed between the front shell 11 and the back shell 12 so that the front shell 11 and the back shell 12 can substantially bend relative to each other.

Preferably, the elastic member 14 includes a soft axis 141 and a soft sleeve 142. One end 14a of the soft axis 141 and the soft sleeve 142 is installed in the front shell 11, and the other end 14a of the soft axis 141 and the soft sleeve 142 is installed in the back shell 12, and a groove 14c is formed on an inner wall 14b of the soft sleeve 142 to clamp with both the front shell 11 and the back shell 12 so as to prevent the two ends 14a of the elastic member 14 from respectively protruding out of the front shell 11 and the back shell 12.

The soft rubber shell 2 includes a housing 21 surrounding around all the front shell 11, the elastic member 14 and the back shell 12 and a massaging concave cover 24. The housing 21 includes a second mounting recess 214 formed, at a position where the convex cap 633 is exposed to the front shell 11 so that the massaging concave cover 24 can cover on the second mounting recess 214. The main body 1 is inserted from the second mounting, recess 214 and then received in the soft rubber shell 2.

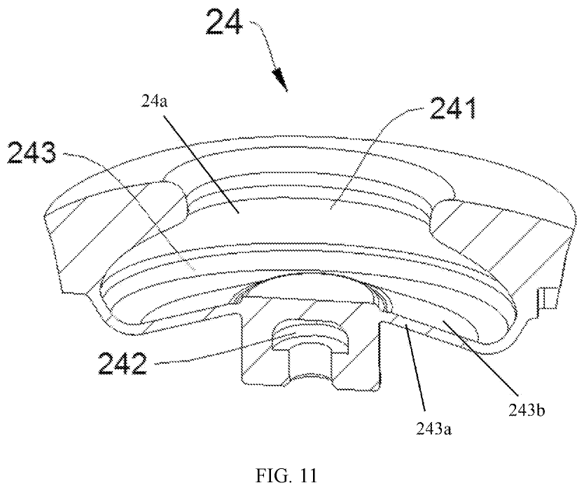

Referring to FIG. 11, the massaging concave cover 24 includes a massaging room 243 with an upper recess 24a thereof to fain the massaging concave 241, and the second clamping cavity 242 formed below the bottom 243a of the massaging room 243. In the, second embodiment of the present disclosure, the convex cap 633 is embedded into the second clamping cavity 242 from the opening 111, so as to drive a bottom wall 243b of the massaging room 243 to move up and down.

A third vibration motor 8 is received in the back shell 12 to drive the back shell 12 to vibrate, and electrically connected to the PCB 3.

That is, the massage device 100 in the second embodiment of the present disclosure, the soft rubber shell 2 positioned in the back shell 12 can also be in contact with the human body through the third vibration motor 8 to provide vibration massage, in addition to provide vibration, negative-pressure adsorbing, stretching and tapping massages by the massaging concave 241 in contact with the human body.

Referring to FIG. 2 and FIG. 8 the massage device 100 according to the first and second embodiments of the present disclosure is provided that the back, shell 12 includes a control button 91 and a charging member 92, both the control button 91 and the charging member 92 exposed outward the back shell 12 and electrically connected to the PCB 3, the charging member 92 passing through the housing 21 and connected with an external power supply to charge the battery 4, and the control button 81 configured to open and close the massage device 100 and control, parameters of the massage device 100. The charging member 92 can be a metal contact or a USB interface.

The first, second and third vibration motors of the massage device 100 of the present disclosure can be integrated with a reduction box or set up a reduction box separately in the massage device 100.

The massage device integrated with electrical pressing, tapping and vibration functions 100 of the present disclosure is applied to massage sexual organs of the human body such as breasts, clitoris, internal prostate, vaginal g-spot and so on by vibrating, pressing, tapping or negative-pressure absorbing and stretching to stimulate convex points or a concave points of the sexual organs of the human body mentioned above for enhancing sexual experience. It can be understood that the massage device 100 of the present disclosure can be applied to acupoint massage of human body.

The massage device integrated with electrical pressing, tapping and vibration functions 100 of the present disclosure is provided that a first vibration motor 5 and a telescopic member 6 installed in a main body 1, a massaging portion 20 including a massaging protrusion 211 or a massaging concave 241 and formed on a position of the soft rubber shell 2 that the telescopic member 6 can expose an end 1a of the main body 1, the first vibration motor 5 rotated with high speed to produce a vibration massage effect and simultaneously drive the telescopic member 6 to reciprocate up and down so that the up and down reciprocating movement of the telescopic member 6 can drive the massaging portion 20 to press, pat, adsorb and stretch a portion in contact with a human body to massage the portion of the human body by vibrating, pressing, patting, adsorbing and stretching the contact point of the human body. The structure of the present disclosure not only can provide a conventional vibration massage effect on the contact point of human body, but also can provide experience effect of pressing, tapping or absorbing stretching and multiple massage combinations of them to improve good personal experience effect.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A massage device integrated with electrical pressing, tapping and vibration functions comprising:
a main body comprising a PCB, a battery, a first vibration motor and a telescopic member, the PCB electrically connected to the first vibration motor and the battery, and the first vibration motor connected to the telescopic member;
a soft rubber shell surrounding, around the main body; and
the telescopic member exposed at one end of the main body and the soft rubber shell comprising a massaging portion at an exposed position of the telescopic member which can expose out of the end of the main body, a bottom portion of the massaging portion connected with the telescopic member; and wherein
the first vibration motor is configured to rotate and vibrate to drive the telescopic member to reciprocate up and down and then drive the massaging portion to press, pat and adsorb a portion in contact with a human body.

2. The massage device integrated with electrical pressing, tapping and vibration functions as claimed in claim 1, wherein the massaging portion is a massaging protrusion arranged outside the soft rubber shell and protruding outward or a massaging concave recessed inside the soft rubber shell or appeared, parallel and level with a surface of the soft rubber shell.

3. The massage device integrated with electrical pressing, tapping and vibration functions as claimed in claim 1, wherein the telescopic member comprises an eccentric gear, an eccentric shaft and a pushing rod connected in turn, one edge of the eccentric gear fixedly connected with an output shaft of the first vibration motor and rotated with the rotation of the first vibration motor, and the other edge of the eccentric gear connected with the eccentric shaft; a lower portion of the, pushing rod sleeved around outside the eccentric shaft and rotatably connected with the eccentric shaft, and an upper portion of the pushing rod exposed out of the main body and connected with the bottom portion of the massaging portion, the eccentric shaft rotating eccentrically with the rotation of the eccentric gear to further drive the pushing rod to reciprocate up and down.

4. The massage device integrated with electrical pressing, tapping and vibration functions as claimed in claim 3, wherein the pushing rod comprises a post formed on a middle thereof, a hollow sleeving member arranged at a lower edge of the post, and a convex cap arranged at an upper edge of the post, the eccentric shaft inserted into the hollow sleeving member to rotate relative to the sleeving member, the convex cap exposed the main body and connected with the bottom portion of the massaging portion.

5. The massage device integrated with electrical pressing, tapping and vibration functions as claimed in claim 4, wherein the soft rubber shell comprises a massaging protrusion formed on a position thereof that the convex cap is exposed, a first clamping cavity formed below a bottom end of the massaging protrusion so that the convex cap can be embedded into the first clamping cavity.

6. The massage device integrated with electrical pressing, tapping and vibration functions as claimed in claim 5, wherein the main body comprises a front shell for receiving the first vibration motor and the telescopic member therein, a back shell for receiving the battery and the PCB therein, and a silicone connecting member connected with the front shell and the back shell, the front shell comprising an opening formed on a top end thereof for the convex cap exposing therefrom;
the soft rubber shell comprising a housing surrounding around all the front shell, the silicone connecting member and the back shell, a massaging bar extending diagonally upward towards the front shell from the housing and a mounting cover, the housing comprising a first mounting recess formed corresponding to a distal end of the back shell so that the mounting cover can cover on the first mounting recess, the massaging protrusion integrated with the housing and formed at a position of the housing where the convex cap is exposed to the front shell; and
a second vibration motor received in the massaging bar to drive the massaging bar to vibrate.

7. The massage device integrated with electrical pressing, tapping and vibration functions as claimed in claim 6 wherein the massaging bar comprises a pair of massaging ears thereon.

8. The massage device integrated with electrical pressing, tapping and vibration functions as claimed in claim 4, wherein the soft rubber shell comprises a massaging concave formed on a position thereof that the convex cap is exposed, a second clamping cavity formed below a lower end of the massaging concave so that the convex cap can be embedded into the second clamping cavity.

9. The massage device integrated with electrical pressing, tapping and vibration functions as claimed in claim 8, wherein the main body comprises a front shell for receiving the first vibration motor and the telescopic member therein, a back shell for receiving the battery and the PCB therein, and an elastic member connected with the front shell and the back shell, the front shell comprising an opening formed on a top end thereof for the convex cap exposing therefrom;
the soft rubber shell comprising a housing surrounding around all the front shell, the elastic member and the back shell, and a massaging concave cover, the housing comprising a second mounting recess formed at a position where the convex cap is exposed to the front shell so that the massaging concave cover can cover on the second mounting recess, the massaging concave cover comprising a massaging room with an upper recess thereof to form the massaging concave, and the second clamping cavity formed below the bottom of the massaging room; and
a third vibration motor received in the back shell to drive the back shell to vibrate.

10. The massage device integrated with electrical pressing, tapping and vibration functions as claimed in claim 9, wherein the back shell comprises a control button and a charging member, both the control button and the charging member exposed outward the back shell and electrically connected to the PCB, the charging member passing through the housing and connected with an external power supply to charge the battery, and the control button configured to open and close the massage device and control parameters of the massage device.

11. The massage device integrated with electrical pressing, tapping and vibration functions as claimed in claim 4, wherein the sleeving member comprises a blocking bar formed on one portion thereof, and a limiting buckle formed on the other portion thereof, one end surface of the eccentric, shaft resisted against the blocking bar and the other end surface of the eccentric shaft held by the limiting buckle, when the eccentric shaft is mounted on the sleeving member.

12. The massage device integrated with electrical pressing, tapping and vibration functions as claimed in claim 6, wherein each expansion joint is formed on a front end and a back end of the silicone connecting member and comprises a slot formed on an outer wall thereof, when the expansion joints at the front end and the back end are respectively received in the front shell and the back shell, the slots are respectively clamped with the front shell and the back shell.

13. The massage device integrated with electrical pressing, tapping and vibration functions as claimed in claim 9, wherein the elastic member comprises a soft axis and a soft sleeve, one end of the soft axis and one portion of the soft sleeve installed in the front shell, and the other end of the soft axis and the other portion of the soft sleeve installed in the back shell, a groove formed on an inner wall of the soft sleeve to clamp with the front and back shells.
